(19) United States
(12) Patent Application Publication
(10) Pub. No.: US 2015/0269335 A1
(43) Pub. Date: Sep. 24, 2015

(54) METHOD AND SYSTEM FOR ESTIMATING VALUES DERIVED FROM LARGE DATA SETS BASED ON VALUES CALCULATED FROM SMALLER DATA SETS

(71) Applicant: ATIGEO LLC, Bellevue, WA (US)

(72) Inventors: Gunjan Gupta, Bellevue, WA (US); Wolf Kohn, Bellevue, WA (US); Robert Payne, Bellevue, WA (US); Aman Thakral, Bellevue, WA (US); Michael Sandoval, Bellevue, WA (US); David Talby, Bellevue, WA (US)

(73) Assignee: ATIGEO LLC, Bellevue, WA (US)

(21) Appl. No.: 14/574,199

(22) Filed: Dec. 17, 2014

Related U.S. Application Data
(60) Provisional application No. 61/916,909, filed on Dec. 17, 2013.

(51) Int. Cl. G06F 19/00; G06F 17/30

(52) U.S. Cl. CPC G06F 19/328; G06Q 40/08; G06F 17/3048; G06F 17/30604

(57) ABSTRACT

The current document is directed to methods and systems for estimating values that could be derived from a large data set, were it available, from values computed from an available smaller data set. A specific example of the currently described methods and systems are methods and systems that estimate various medical-record-related statistics and values computed from hypothetical datasets. In order to extrapolate the desired statistics and computed values from the observed smaller data set, multiple models are employed by the currently disclosed methods and systems. These models can be employed sequentially to generate relatively fine-grained estimates over various multi-dimensional data-set volumes.

### CROSS-REFERENCE TO RELATED APPLICATION

This application claims the benefit of Provisional Application No. 61/916,909, filed Dec. 17, 2013.

### TECHNICAL FIELD

The current document is directed to methods and systems for estimating values that could be derived from a large data set, were it available, from values computed from an available smaller data set and, in a particular example, to methods and systems that estimate aggregate computed results for a large, hypothetical medical-claims-related data set based on a smaller medical-claim-related dataset.

### BACKGROUND

Processing of medical claims is a large and complicated endeavor that is cooperatively carried out by many different entities, including insurance companies, claims-processing institutions, claim-payer institutions, various types of medical-services providers, and patients. An enormous volume of medical claims is processed each year in the United States. The various entities involved in claim processing, including claims-processing institutions, often desire to monitor and track trends in the types of claims and volumes of claims generated by various patient segments, on a nationwide basis, in order to predict the need for increased claims-processing capacities and infrastructure, market services in underserved areas, facilitate epidemiological research and other types of medical research, for planning for employee hiring and benefits, and for many other reasons. However, currently, the various institutions involved in medical-claim processing may directly observe only a small sub-volume of the total volume of medical-claim transactions that occur in a geographical area over a particular period of time. Therefore, these institutions continue to seek systems and methods that would allow accurate estimation of medical-claim-related statistics and other computed values based on only a subset of the medical-claim transactions observed by the institutions.

### SUMMARY

The current document is directed to methods and systems for estimating values that could be derived from a large data set, were it available, from values computed from an available smaller data set. A specific example of the currently described methods and systems are methods and systems that estimate various medical-record-related statistics and values computed from hypothetical datasets, including the number of claims per patient per unit amount of time for various patient segments and the number of claims of a particular type per patient per unit amount of time for various patient segments. Often, the estimates are desired for an entire nation or a large geographical area within a nation, even though data for only smaller subset of the theoretical data set can be directly observed. In order to extrapolate the desired statistics and computed values from the observed smaller data set, multiple models are employed by the currently disclosed methods and systems. These models can be employed sequentially to generate relatively fine-grained estimates over various multi-dimensional data-set volumes.

### BRIEF DESCRIPTION OF THE DRAWINGS

FIG. 1 illustrates a medical-claims processing environment.

FIG. 2 illustrates a medical-claim-related estimation problem domain.

FIGS. 3A-G illustrate some of the phenomena that would frustrate simple scaling of statistics and computed values based on the medical-claim transactions observed by a particular medical-claim processing institution in order to estimate statistics and computed values for large geographical areas or for a large fraction of patients within particular patient segments.

FIG. 4 illustrates the subset of medical claims handled by a particular claim processor.

FIG. 5 illustrates a set of all patients which submit claims over a unit period of time, such as a year, and various subsets of this set related to a particular claim-processing institution.

FIGS. 6A-B illustrate one observed phenomena with respect to claims per patient statistics.

FIG. 7 illustrates a second observed phenomenon with respect to claims per patient statistics.

FIG. 8 illustrates a state-transition model underlying a first estimation model.

FIG. 9 shows an example set of results in which the value of the parameter a is plotted with respect to the vertical axis and the value of f is plotted with respect to the horizontal axis for a large number of simulations.

FIG. 10 illustrates a multi-dimension claims-per-patient volume.

FIG. 11 provides a general architectural diagram for various types of computers.

### DETAILED DESCRIPTION

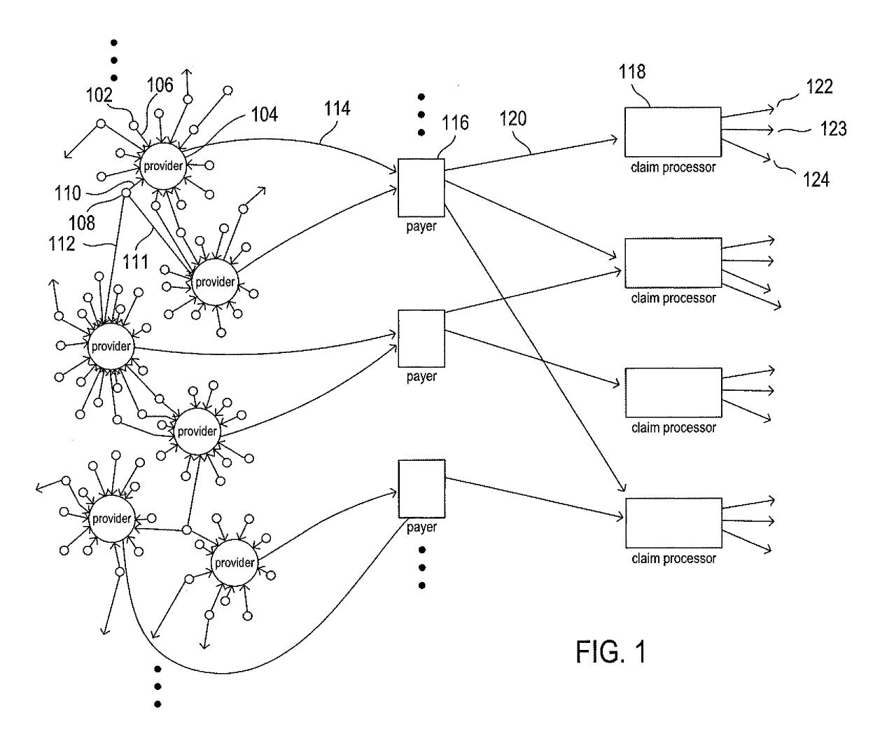

FIG. 1 illustrates a medical-claims processing environment. As shown in FIG. 1, patients, each represented by a small disk, such as disk 102, receive medical services from medical-service providers, represented by larger disks, such as disk 104. The service-providing relationship is indicated by a directed edge, or arrow, 106 from the patient 102 to the medical-service provider 104. As shown in FIG. 1, a particular patient, such as patient 108, may receive medical services from multiple medical-service providers, as indicated by arrows 110-112. The medical-service providers submit, to medical-claim-payer institutions, claims for reimbursement for services provided to patients. The submission of claims is also represented by arrows in FIG. 1, such as arrow 114 that represents submissions of medical claims by medical-service provider 104 to medical-claim payer institution 116. The medical-claim-payer institutions, in turn, submit claims to claims-processing institutions, such as claims-processing institution 118. Arrows, such as arrow 120, represent submission of claims by a medical-claim-payer institution to a claims-processing institution in FIG. 1. The claims-processing institutions, in turn, submit claims to insurance companies, as indicated by arrows emanating from the claims-processing institutions, such as arrows 122-124 emanating from claims-processing institution 118.

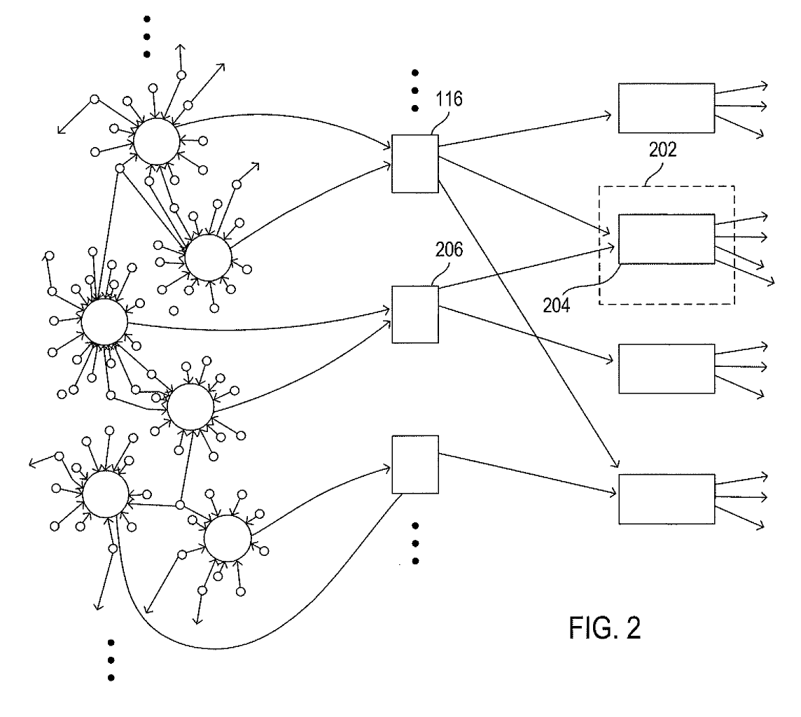

Claims-processing institutions, as one example of a problem domain addressed by the currently described methods and systems, may wish to infer various statistics and hypothetical computed values, such as the number of claims, on average, submitted for the average patient of a particular segment, such as adults between the ages of 21 and 40, living in metropolitan areas of the US. Often, they wish to estimate these parameters and statistics based on the medical-claim transactions in which they directly participate. However, the medical-claim transactions in which a particular institution participates may be a relatively small subset of the total number of medical-claim transactions carried out over unit periods of time for the patient segment of interest. In addition, statistics and values computed from small data sets may be significantly skewed and biased as a result of the effect of non-uniform sampling of the total medical-claim-related transactions by a particular institution. FIG. 2 illustrates a medical-claim-related estimation problem domain. As shown by a dashed box 202 around the claims-processing institution 204, claims-processing institution 204 may wish to estimate various types of nationwide medical-claim-related statistics and values that would be computed from a complete medical-claims data set, but directly observes only those medical claims forwarded to the claims-processing institution by medical-claim-payer institutions 116 and 206. These medical-claim-payer institutions, in turn, receive claims from only a subset of the total number of medical-service providers and patients.

At first impression, one might assume that a particular claims-processing institution would need only to accurately estimate the fraction of patients handled by the particular claims-processing institution as well as the fraction of claims handled by the particular claims-processing institution in order to be able to scale statistics and values computed from the medical-claim transactions observed by the particular claims-processing institution in order to accurately estimate corresponding statistics and computed values for much larger medical-claim-transaction sets, including all of the medical-claim transactions carried out within a nation or large region of a nation during the course of a year. However, that is not the case. There are many different types of phenomena that render such simplistic estimation methods inaccurate and inadequate.

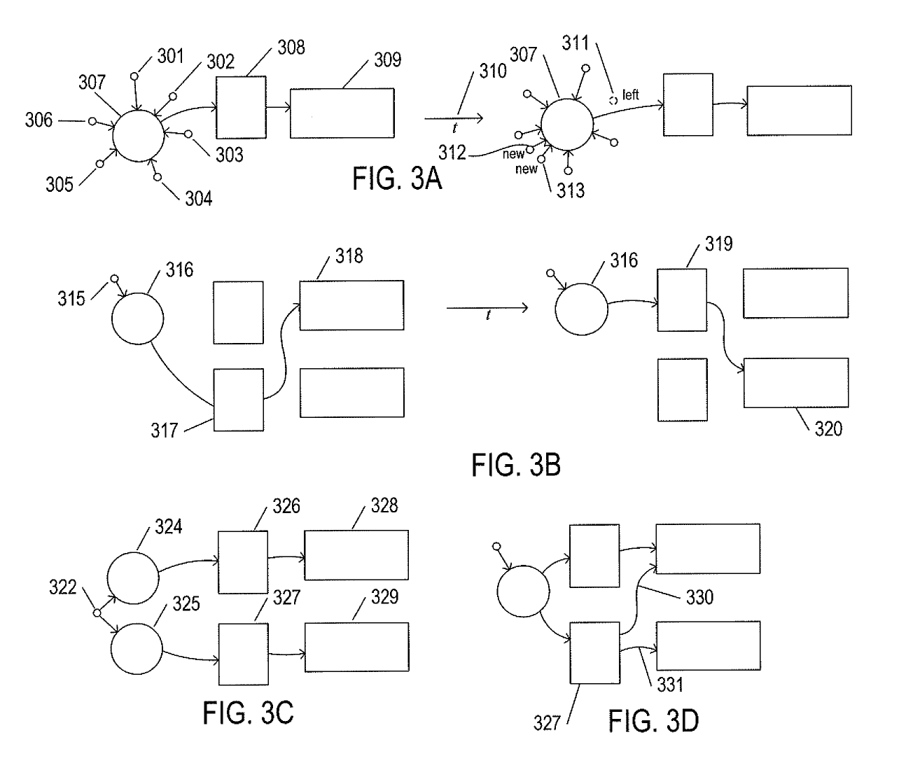

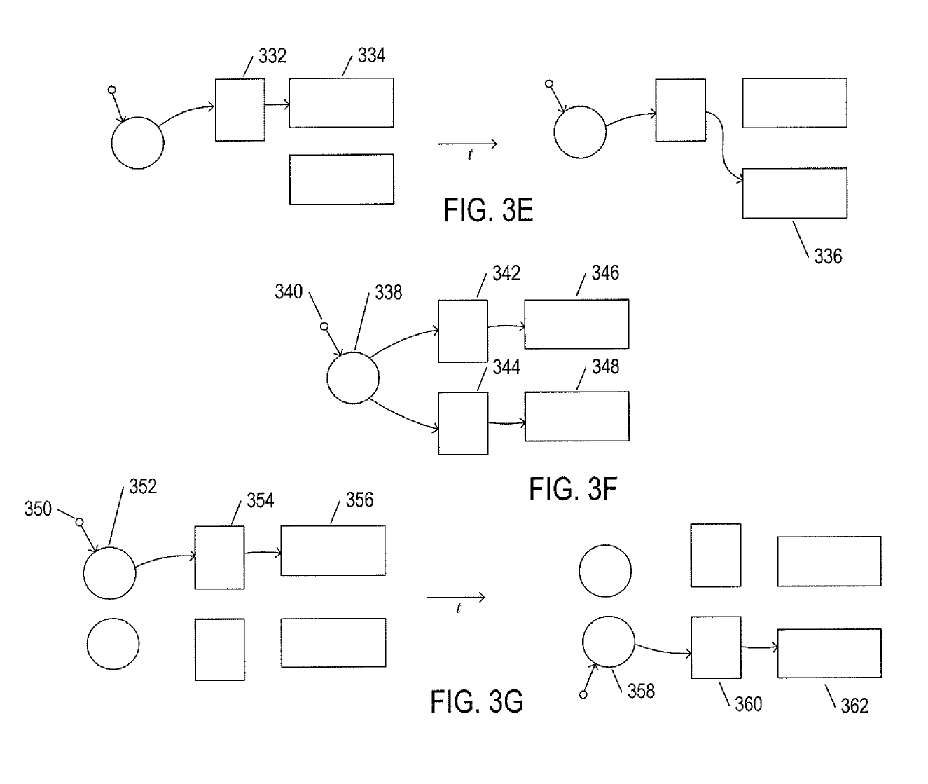

FIGS. 3A-F illustrate some of the phenomena that would frustrate simple scaling of statistics and computed values based on the medical-claim transactions observed by a particular medical-claim processing institution in order to estimate statistics and computed values for large geographical areas or for a large fraction of patients within particular patient segments. FIGS. 3A-F use the same illustration conventions as used in FIGS. 1 and 2. In addition, directed arrows labeled with the letter “t” indicate the passage of time.

In FIG. 3A, a number of patients 301-306 receive medical services from a medical service provider 307. Medical provider 307 submits claims through payer institution 308 to a claims-processing institution 309. However, after a certain passage of time 310, patient 302 no long receives services from medical-service provider 307, as indicated by the small dashed circle 311, and two new patients 312 and 313 who did not initially receive medical services from medical-service provider 307 now receive medical services from medical-service provider 307. As a result, were the claims-providing institution 309 to attempt to estimate certain claims-related statistics and computed values over a larger interval of time that includes the interval of time represented by arrow 310, the claims-processing institution may underestimate claims-per-patient statistics and computed values due to the fact that only a fraction of the total claims submitted on behalf of patients, such as patients 302 and 312-313, who migrated to or away from the claims-providing institution during the time interval were handled by the claims-providing institution. Similarly, as shown in FIG. 3B, a particular patient 315 receiving medical services from a medical-service provider 316 may generate claims that are initially transmitted to a first claim-paying institution 317 that forwards the claims to a first claims-processing institution 318. However, after a passage of time, the medical-service provider 316 may change to submitting claims to a second claim-payer institution 319 which forwards claims to a second, different claims-processing institution 320. Thus, both claims-processing institutions 318 and 320 observe claims from medical-service provider 316 for only a portion of a unit of time, such as a year. Were they to estimate claim-related statistics and values for an entire year based on the observed medical-claim transactions that they handle, they would likely significantly underestimate claims-per-patient statistics and values for particular patient segments.

As shown in FIG. 3C, a particular patient 322 may receive medical services from two different medical-service providers 324-325 which each submit claims to different payer institutions 326 and 327, respectively. Payer institutions 326 and 327, in turn, each uses different claims-processing institutions 328 and 329, respectively. Were either of claims-processing institutions 328 or 329 to estimate statistics and other values based on the observed claims from patient 322, those estimates may be significantly lower than the actual value for that patient due to the fact that each claims-processing institution only observes a fraction of the claims generated by the patient. As shown in FIG. 3D, the situation shown in FIG. 3C may be additionally complicated by the fact that one of the payer institutions 327 may submit claims to multiple claims-processing institutions, as represented by arrows 330-331.

As shown in FIG. 3E, a particular payer institution 332 may, over the course of a unit of time, switch from forwarding claims to a first claims-processing institution 334 to forwarding claims to a second claims-processing institution 336. As shown in FIG. 3F, a particular medical-services provider 338 may forward claims for a particular patient 340 to multiple payer institutions 342 and 344, each of which forwards claims to a different claims-processing institution 346 and 348, respectively. As shown in FIG. 3G, a particular patient 350 that initially uses a first medical-services provider 352, which forwards claims through a first payer institution 354 to a first claims-processing institution 356 may move, or migrate, over the course of time, to a different medical-services provider 358 which forwards claims through a different payer institution 360 to a different claims-processing institution 362.

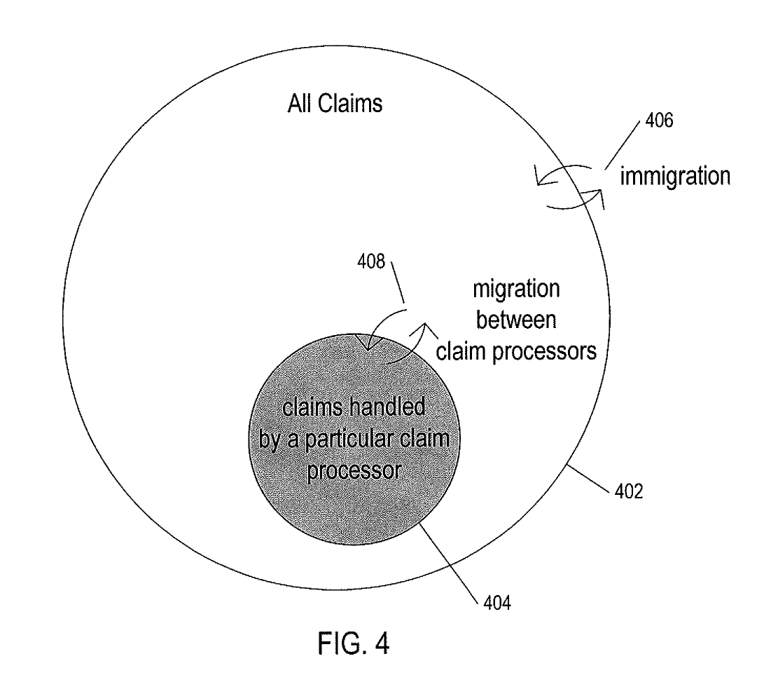

FIG. 4 illustrates the subset of medical claims handled by a particular claim processor. In FIG. 4, the outer circle or larger disk 402 represents all claims generated within a large geographical area, such as a nation, over a unit period of time, such as a year. The inner, shaded disk 404 represents those claims handled by a particular claim processor. Neither the total number of claims nor the number of claims handled by the particular claim processor are stable, over time, for various different reasons. One reason is that, as indicated by double arrows 406, patients may migrate into and away from the particular geographical region over the course of the year. Another factor to be considered is that, as discussed above, patients, medical-service providers, and payer institutions may migrate between claims processors over the course of the year, as indicated by double arrows 408.

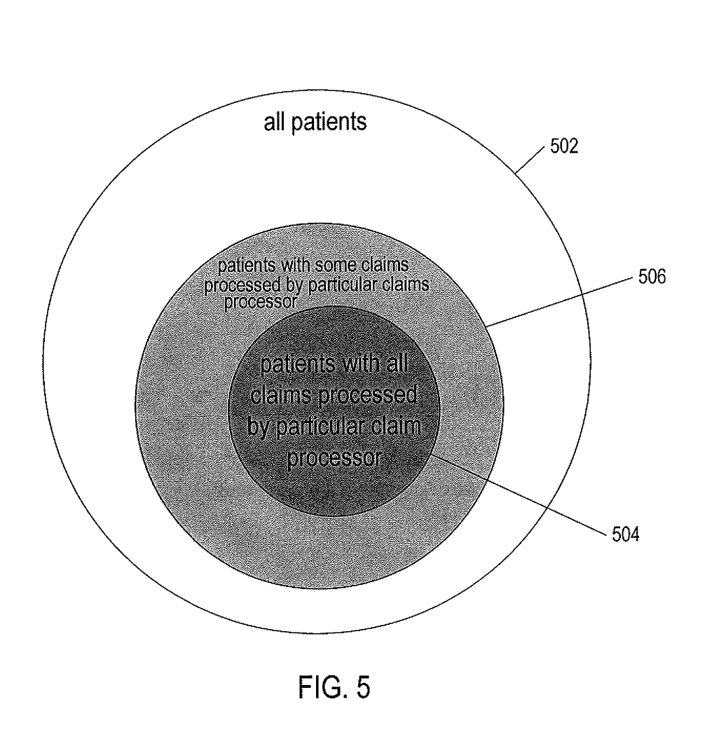

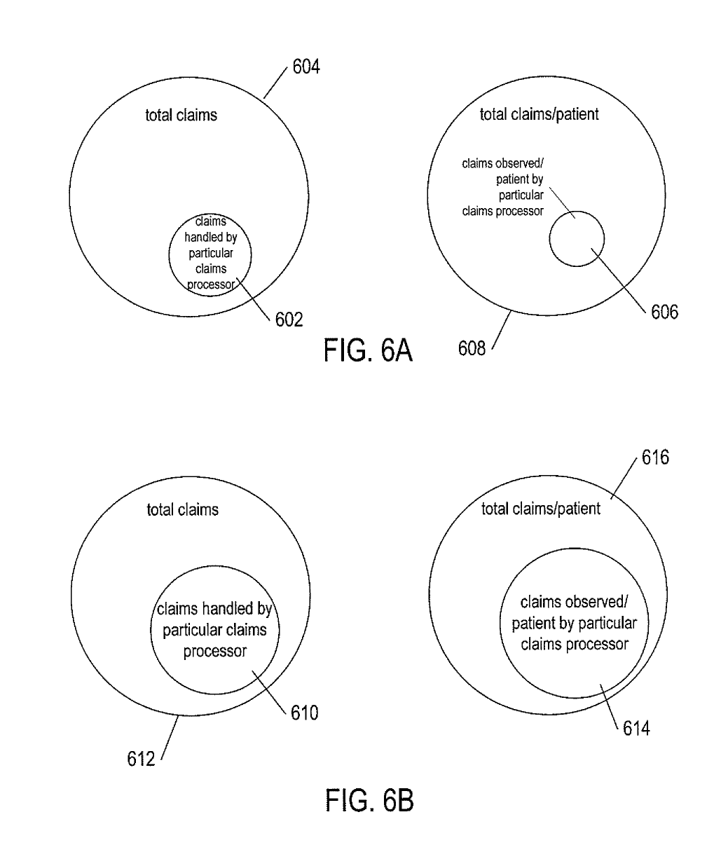

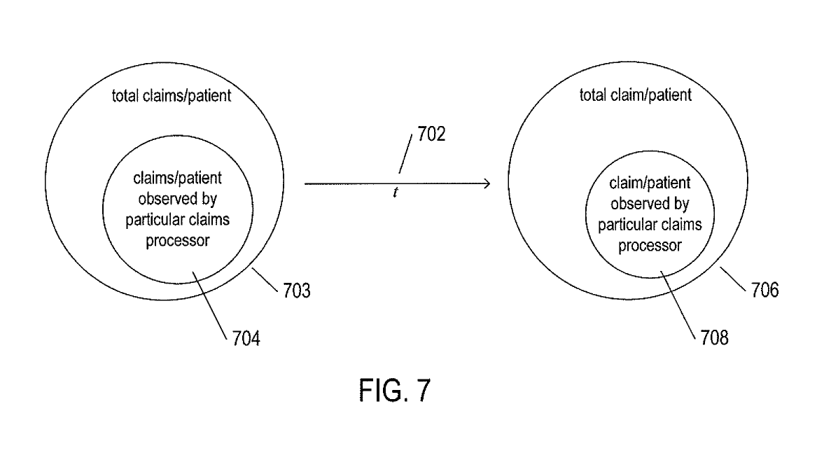

FIG. 5 illustrates a set of all patients which submit claims over a unit period of time, such as a year, and various subsets of this set related to a particular claim-processing institution. FIG. 5 uses similar illustration conventions as used in FIG. 4 and as used in subsequent FIGS. 6A-7. A set of all patients who generate medical claims for some geographical area over the unit time is represented by the outer disk 502. All of the claims generated by a small subset of these patients may be handled by particular claims-processing institution 504. However, due to the many phenomena discussed above with reference to FIGS. 3A-F and FIG. 4, these patients generally represent only a subset of the patients for which the particular claims-processing institution processes claims during the course of the year or other unit of time 506. As a result, the particular claims-processing institution cannot make accurate estimates of various statistics and values related to medical claims based only on the claims observed during the course of a year or based on the patients observed during the course of a year, since both the claims handled by the claims-processing institution may be unstable over time due to migration, as discussed with reference to FIG. 4, and because many of the patients for which the claims-processing institution processes claims may have generated additional claims that were processed by another claims-processing institution.

FIGS. 6A-B illustrate one observed phenomena with respect to claims per patient statistics. As shown in FIG. 6A, a particular claims-processing institution handles a particular subset 602 of the total claims processed in a geographical area during a unit period of time. Due to the above-discussed phenomena of unobserved claims, a particular claims-processing institution may observe a fraction 606 of claims generated per patient with respect to an actual number of claims generated per patient 608 during the unit time. However, as the fraction of the number of claims handled by the particular claims-processor with respect to the total claims increases, as indicated by the relative magnitudes of the ratio of the sizes of subset 610 and the set of total claims 612 in FIG. 6B and the ratio of the sizes of subset 602 and the set of total claims 604 in FIG. 6A, the number of claims observed per patient by the particular claims processor 614 is a much larger fraction of the total claims generated per patient 616. Clearly, as the fraction of the total processed claims handled by a particular claims processor increases, the probability that a particular patient or medical-services provider will migrate away from or into the claims-processing institution decreases, and the fraction of the total claims of the patients seen by the claims-processing institution that are unobserved by the claims-processing institution significantly decreases. The fraction of claims handled by a particular claims-processing institution is generally related to the fraction of payers which submit claims to the particular claims-processing institution, so that the trends illustrated in FIGS. 6A-B may also be observed with respect to the fraction of the total number of payer institutions which submit claims to the particular claims-processing institution.

FIG. 7 illustrates a second observed phenomenon with respect to claims processing. As shown in FIG. 7, over time 702, the claims per patient observed by a particular claims-processing institution 704 with respect to the total claims per patient generated decreases, as shown by the relative areas of subset 708 to set 706 and subset 704 to set 703. This phenomenon is due to the fact that, over time, the probability that some number of patients, medical-service providers, and payer institutions migrate away from or into the claims-processing institution increases, as a result of which the average number of unobserved claims per patient handled by the particular claims-processing institution also increases.

As a result of the various phenomena discussed above with reference to FIGS. 3A-7, the current document discloses methods and systems that use three estimation models to estimate various claims-related statistics and computed values from the claims processed by a claims-processing institution. In other words, the claims processed by the claims-processing institution is a subset of the total number of claims and the patients observed to have submitted claims by the claims-processing institution is a subset of the total number of patients. Using the models, discussed below, the claims-processing institution can adjust computed statistics, such as the number of claims generated per patient per patient segment, for sample size and bias.

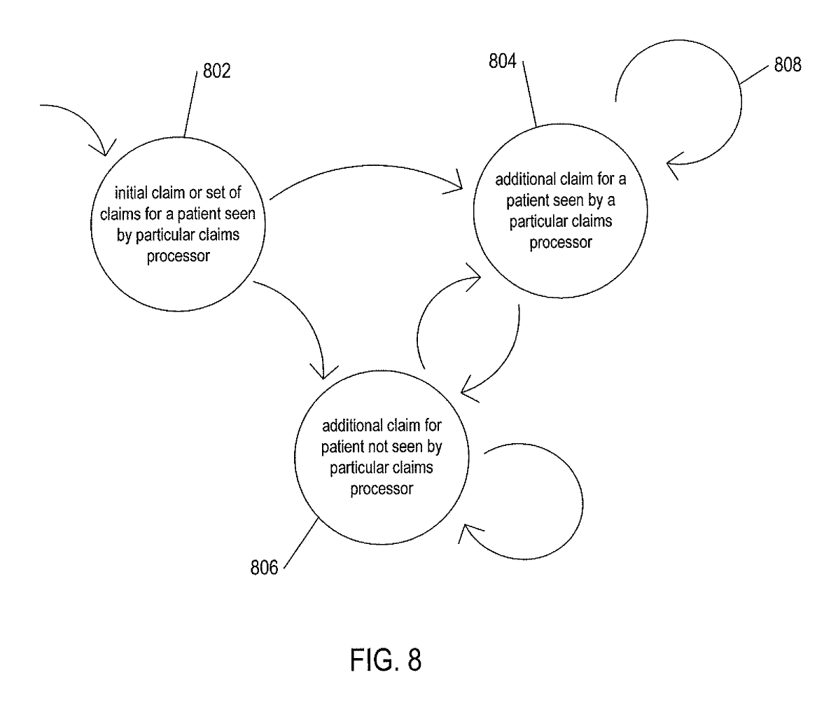

FIG. 8 illustrates a state-transition model underlying a first estimation model. During a unit period of time, a patient becomes observed by a claims-processing institution when an initial claim is submitted on behalf of the patient to the claims-processing institution. The initial submission of a claim or claims on behalf of a patient is represented by a first, or start, state 802. Thereafter, during the remaining period of time within the unit period of time, an additional claim may be submitted to the particular claims-processing institution on behalf of the patient, as represented by state 804. In addition, a claim may be submitted on behalf of the patient to another claims-processing institution, and thus represent an unobserved claim for the patient, as represented by state 806. The possible transitions between these states are represented by curved arrows, such as curved arrow 808. When the initial claim or claims for a patient are received by the particular claims-processing institution, additional claims may have also been submitted to other claims processing institutions. The total number of claims submitted on behalf of the patient at the initial state is therefore unknown, and represented by the parameter a.

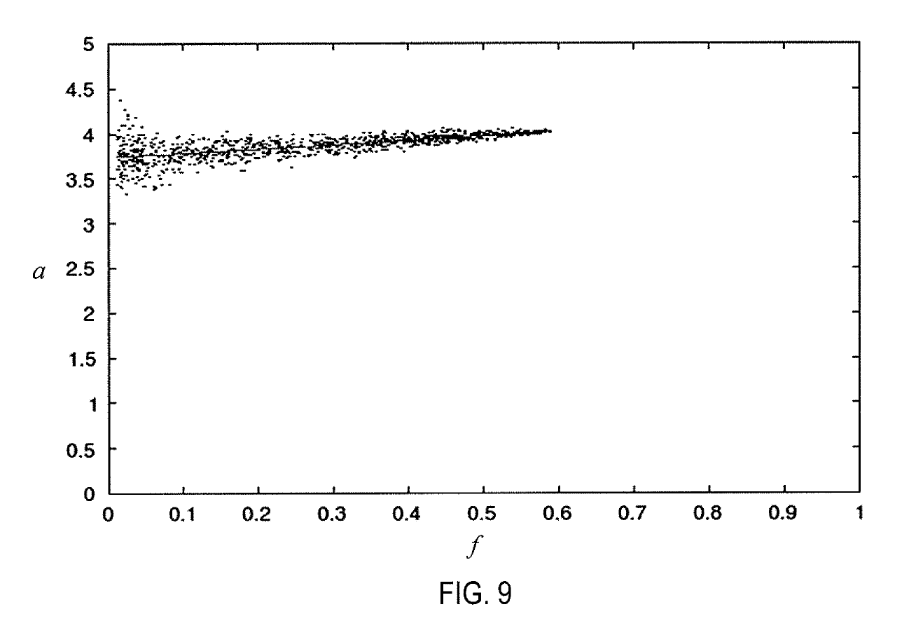

The first estimation model is described by the following expression:

$${n}_{true}^{′} = a + ( {n}_{obs} - a ) ( 1 + \frac{1 - f}{f} {p}_{t} )$$

where n′ₜᵣᵤₑ=true average number of claims;
   n_{obs}=number of observed claims;
   f=fraction of patients for whom claims are submitted to payers that submit claims to the particular claims-processing institution;
   a=average number of claims generated in initial visit by each patient; and
   pₜ=average number of payer switches made by each patient.
      In this model, it is assumed that payers who submit claims to the particular claims-processing institution submit all of their claims to the claims-processing institution. In essence, the model attempts to adjust the number of observed claims upward to reflect the fact that patients may migrate to payers that do not submit claims to the particular claims-processing institution, as represented by state 806 in FIG. 8. The value n_{obs} is the number of claims observed per patient by a particular claims-processing institution. This number is known. The values of the parameters a and pₜ, which, like n_{obs}, are per-patient values, are generally not known. However, it is possible to derive values for these parameters by sampling-based analysis of the claims processed by the particular claims-processing institution. Certain of the paying institutions that submit claims to the claims-processing institution may be known to submit all of their claims to the claims-processing institution. Therefore, subsets of the claims processed by the claims-processing institution can be selected for which f can be computed, using census data. Then, simulations can be carried out for these subsets, with known f, in which the values of the parameters a and pₜ are varied over reasonable ranges. As a result of these simulations, distributions of the values for parameters a and pₜ are obtained. FIG. 9 shows an example set of results in which the value of the parameter a is plotted with respect to the vertical axis and the value off is plotted with respect to the horizontal axis for a large number of simulations. Various types of multi-variate regression can be employed, or other statistical methods can be employed, to estimate the values of the parameters a and pₜ from these distributions. Using these estimated values for the parameters a and pₜ, and estimating the value f based on knowledge of payer institutions and the relative proportion of payer institutions serviced by the claims-processing institution, a corrected number of observed claims, n′ₜᵣᵤₑ, can be computed from of a number of observed claims.

A second model corrects n′ₜᵣᵤₑ, obtained from the first model, to account for the fact that only a portion of the payer institutions that submit claims to a particular claims-processing institution are, in fact, sending claims exclusively to the particular claims-processing institution:

$${n}_{true} = \frac{{N}_{obs}}{{N}_{obs}^{′}} {n}_{true}^{′}$$

where nₜᵣᵤₑ=true number of claims;
   n′ₜᵣᵤₑ=number of claims captured from model 1;
   N_{obs}=number of claims observed from exclusive payers; and
   N′_{obs}=number of claims observed from exclusive payers according to model 1.
      As with the first model, the values used in the second model are per-patient values. In the case that exclusive-payer information is not available, nₜᵣᵤₑ can be set to n′ₜᵣᵤₑ:

$${n}_{true} = {n}_{true}^{′} , \\ where \frac{{N}_{obs}}{{N}_{obs}^{′}} = 1.$$

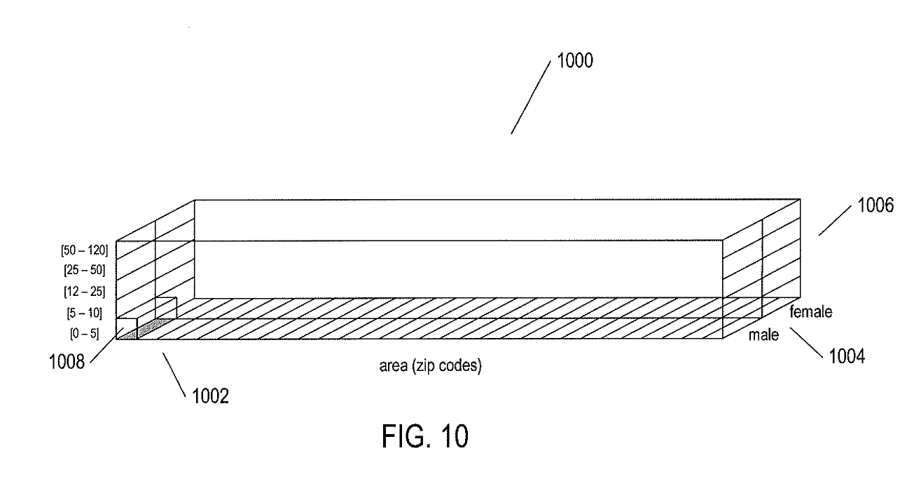

A third model allows the statistics and parameter estimation for large data sets to be carried out at relatively high granularity within a multi-dimension claims-per-patient data volume. FIG. 10 illustrates a multi-dimension claims-per-patient volume. In FIG. 10, the claims-per-patient volume is described by three dimensions. A first dimension 1002, corresponding to the Cartesian x axis of the volume, represents geographical area. The dimension is incremented by zip code. A second dimension 1004, corresponding to the Cartesian y axis, represents the gender of a patient. A third dimension 1006, corresponding to the Cartesian z axis, represents the age range of the patient. The claims-per-patient data set volume 1000 is thus divided into a large number of cells, such as cell 1008, with each cell characterized by a particular zip code, a particular gender, and a particular age range. The third model models the number of claims observed per patient for the patients represented by a cell as follows:

$${n}_{c} = \frac{( {n}_{c\_obs} + {kn}_{true} )}{( β {p}_{c\_obs} + k )}$$

where n_{c}=true number of claims observed in a cell;
   n_{c}_{_{—}}_{obs}=observed number of claims in the cell;
   p_{c}_{_{—}}_{obs}=number of patients in cell;
   k=a smoothing constant; and
   β=a determined constant of migration.
      A global constraint for the model is provided by the expression:

$${n}_{true} = {\sum }_{i ∈ cells} ( \frac{{n}_{c\_obs , i}}{β {p}_{c\_obs , i}} ) {m}_{i}$$

where nₜᵣᵤₑ=the observed number of claims per patient obtained from the second model; and
   mᵢ=the fraction of the total population within the geographical area represented by the cell.
      The value of the migration constant β can be obtained from the expression:

$$β = {\sum }_{i ∈ cells} \frac{( {n}_{c\_obs , i} ) ( {m}_{i} )}{( {p}_{c\_obs , i} ) ( {n}_{true} )} .$$

The currently described methods are necessarily carried out computationally on computer systems. They cannot be carried out by hand or by non-computational methods, because they involve computing estimates based on very large numbers of claims and patients, which often include hundreds of thousands, millions, or more patients and claims. Manual calculation would result in a great number of errors and would take tens of years or more for even dedicated teams of human calculators, which would render the final results useless, since accurate results are needed at the time that claims are processed or during relatively short periods of time thereafter. Furthermore, the patient claims are processed by automated methods, in large data centers, and the current described methods are necessarily incorporated into these automated systems. Although the above-described methods are summarized using mathematical notation, the mathematical notation describes a computational process carried out by one or more computer systems. The mathematical notation is no less a complete and specific description of the methods than a computer program that implements the methods. Furthermore, the methods described above are, in no way, inherent in currently practiced automated claims processing systems and are not inherent in general statistical practices and theories or currently available data-processing systems. They represent new and useful data methods that can be incorporated into automated claims-processing computational systems in order to generate more accurate estimates of various types of values, such as the number of claims generated per patient per patient segment, that cannot be computed directly due to the fact that the claims processed by any particular claims-processing system represent, in general, only a subset of the claims processed for patients and patient segments.

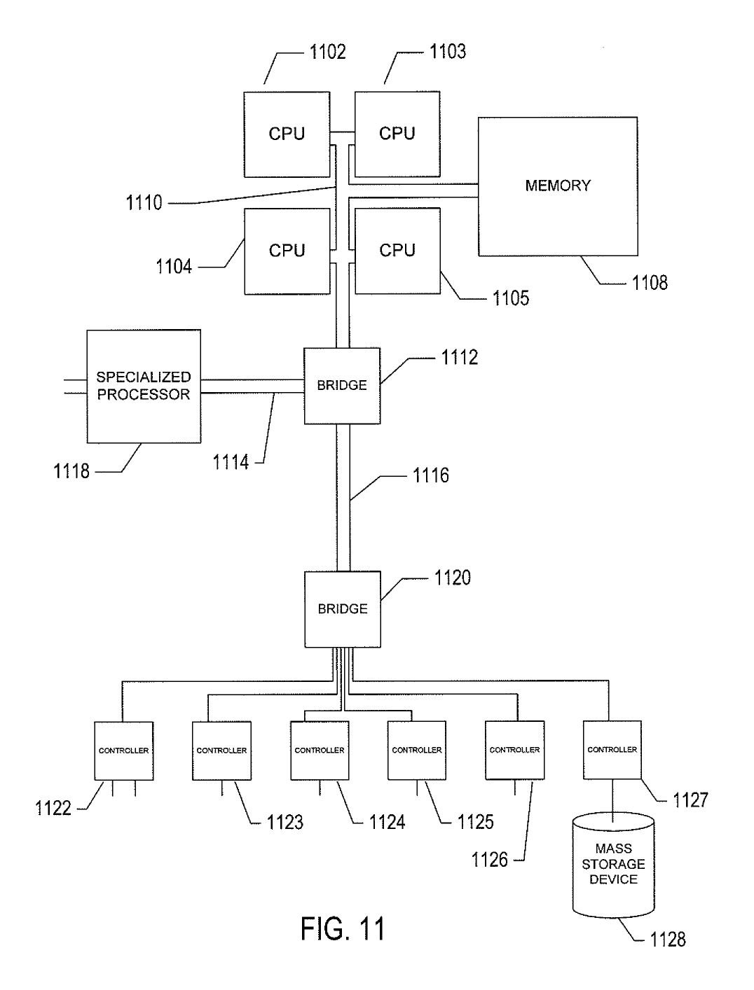

FIG. 11 provides a general architectural diagram for various types of computers. Computers that process medical claims may be described by the general architectural diagram shown in FIG. 11, for example. The computer system contains one or multiple central processing units (“CPUs”) 1102-1105, one or more electronic memories 1108 interconnected with the CPUs by a CPU/memory-subsystem bus 1110 or multiple busses, a first bridge 1112 that interconnects the CPU/memory-subsystem bus 1110 with additional busses 1114 and 1116, or other types of high-speed interconnection media, including multiple, high-speed serial interconnects. These busses or serial interconnections, in turn, connect the CPUs and memory with specialized processors, such as a graphics processor 1118, and with one or more additional bridges 1120, which are interconnected with high-speed serial links or with multiple controllers 1122-1127, such as controller 1127, that provide access to various different types of mass-storage devices 1128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Although the present invention has been described in terms of particular embodiments, it is not intended that the invention be limited to these embodiments. Modifications within the spirit of the invention will be apparent to those skilled in the art. For example, a large number of alternative implementations of the described methods and systems can be obtained by varying any of many different design and implementations parameters, including hardware platform, operating system, virtualization system, data structures, control structures, modular organization, programming language, and many other such parameters. The currently described estimation models are representative of a larger set of related parameterized estimation models that can be used to estimate statistics and other computed data values from data subsets. The extrapolation technique is readily extensible to several problem domains that involve well-defined entities and their consumption or behavioral patterns spread across a large population and geographical location. One such problem domain involves estimating consumption metrics for a consumable product spread across a chain of stores. The individual store IDs, in this problem domain, replace the payer ID in the above-discussed example, the individual customer ID replaces the patient ID, and a product or a product segment replaces the claim type. The effect of customer migration and fragmentation on metrics when measured by store and by region is equivalent to the effect of patient metrics across payers. Smaller product-consumption raw metrics are observed when measuring without the extrapolation corrections. After correction by the above-discussed methods, the estimated product-consumption numbers much more closely represent the true consumption. This can be very useful for a company trying to estimate the consumption numbers for different product and product categories by region in order to direct resources to the products with greatest consumption. Use of the raw, uncorrected product-consumption numbers can lead to severe errors in downstream models and misallocation of resources.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method incorporated into an automated system for estimating a per-submitting-entity numeric value for a large data set that includes multiple data entities submitted by multiple submitting entities to multiple automated data-entity processing systems, were the large data set available, from a per-submitting-entity numeric value computed from a smaller data set that includes multiple data entities submitted by multiple submitting entities to a single automated data-entity processing system, the method carried out in a computer system that includes one or more processors, one or more memories, and one or more mass-storage devices, the method comprising:
computing the per-submitting-entity numeric value from the smaller data set;
correcting the computed per-submitting-entity numeric value for migration of submitting entities between automated data-entity processing systems, using a first estimation model, to produce a corrected per-submitting-entity numeric value; and
correcting the corrected per-submitting-entity numeric value for non-exclusivity of submission by submitting entities to automated data-entity processing systems, using a second estimation model, to produce an estimate of the per-submitting-entity numeric value that would be derived from the large data set, were it available.

2. The method of claim 1 wherein the first estimation model computes a corrected number of submissions per submitting entity as the sum of an average number of initial submissions and a first term computed as the product of a first factor and a second factor, the first factor computed as the difference between the observed number of submissions per submitting entity and the average number of initial submissions per submitting entity and the second factor computed as the sum of 1 and a second term computed by multiplying the average number of switches made per time period between automated data-entity processing systems by submitting entities by a ratio of a fraction of submitting entities that do not submit data entities to the single automated data-entity processing system to the fraction of submitting entities that do submit data entities to the single automated data-entity processing system.

3. The method of claim 1
wherein the submitting entities are patients of medical-services providers;
wherein the data entities are medical claims; and
wherein the data-entity processing systems are medical-claims-processing institutions.

4. A data-processing system comprising:
one or more processors;
one or more memories;
one or more mass-storage devices; and
computer instructions, encoded in a physical computer-instruction-storage device, that control the data-processing system to
estimate the average number of claims, a, generated in an initial visit by each patient to a medical service that submits claims through a medical-claims-paying institution to a medical-claims-processing institution,
estimate the average number of times, pₜ, a patient changes from one medical-claims-paying institution to another medical-claims-paying institution during a time interval,
observe and record, in a physical data-storage device, an observed number of medical claims, n_{obs}, filed during the particular time interval, to a particular medical-claims-processing institution, and
estimate an average total number medical claims, n′ₜᵣᵤₑ, filed during the particular time interval based on the observed number of medical claims, n_{obs}, that represents a fraction of the total number medical claims filed during the particular time interval.

5. The data-processing system of claim 4 wherein the average number of claims a and the average number of times a patient changes from one medical-claims-paying institution to another medical-claims-paying institution pₜ are estimated from a subset of the claims processed by the particular claims-processing institution submitted by one or more medical-claims-paying institutions that submit all of the medical claims they receive to the particular claims-processing institution.

6. The data-processing system of claim 5 wherein the average number of claims a and the average number of times a patient changes from one medical-claims-paying institution to another medical-claims-paying institution pₜ are estimated by:
determining, from census data, a fraction of patients whose medical claims are submitted to the one or more medical-claims-paying institutions that submit all of the medical claims they receive to the particular claims-processing institution;
simulating the submission of medical claims to the one or more medical-claims-paying institutions that submit all of the medical claims they receive to the particular claims-processing institution with various values for a and pᵢ to obtain distributions for the values of a and pₜ; and
and estimating a and pₜ from the obtained distributions.

7. The data-processing system of claim 4 wherein the average total number medical claims n′ₜᵣᵤₑ based on the observed number of medical claims n_{obs} is estimated by:
using the estimated values a and pₜ to estimate the fraction f of patients whose claims are submitted to medical-claims-paying institutions that submit medical claims to the particular claims-processing institution based on a relative proportion of medical-claims-paying institutions serviced by the particular claims-processing institution; and
determining n′ₜᵣᵤₑ, as the sum of a and the product of a first term n_{obs}-a and a second term
$$1 + \frac{1 - f}{f} {p}_{t} .$$

8. The data-processing system of claim 4 further including correcting the average total number medical claims n′ₜᵣᵤₑ to account for the fact that only a portion of the medical-claims-paying institutions that submit medical claims to the particular claims-processing institution exclusively submit medical claims to the particular claims-processing institution.

9. A method carried out in a data-processing system having one or more processors, one or more memories, one or more mass-storage devices, and computer instructions, encoded in a physical computer-instruction-storage device, that control the data-processing system to carry out the method, the method comprising:
estimating the average number of claims, a, generated in an initial visit by each patient to a medical service that submits claims through a medical-claims-paying institution to a medical-claims-processing institution,
estimating the average number of times, pₜ, a patient changes from one medical-claims-paying institution to another medical-claims-paying institution during a time interval,
observing and recording, in a physical data-storage device, an observed number of medical claims, n_{obs}, filed during the particular time interval, to a particular medical-claims-processing institution,
estimating an average total number medical claims, n′ₜᵣᵤₑ, filed during the particular time interval based on the observed number of medical claims, n_{obs}, that represents a fraction of the total number medical claims filed during the particular time interval; and
storing the estimated average total number medical claims, n′ₜᵣᵤₑ.

10. The method of claim 9 wherein the average number of claims a and the average number of times a patient changes from one medical-claims-paying institution to another medical-claims-paying institution pₜ are estimated from a subset of the claims processed by the particular claims-processing institution submitted by one or more medical-claims-paying institutions that submit all of the medical claims they receive to the particular claims-processing institution.

11. The method of claim 10 wherein the average number of claims a and the average number of times a patient changes from one medical-claims-paying institution to another medical-claims-paying institution pₜ are estimated by:
determining, from census data, a fraction of patients whose medical claims are submitted to the one or more medical-claims-paying institutions that submit all of the medical claims they receive to the particular claims-processing institution;
simulating the submission of medical claims to the one or more medical-claims-paying institutions that submit all of the medical claims they receive to the particular claims-processing institution with various values for a and pₜ to obtain distributions for the values of a and pₜ; and
estimating a and pₜ from the obtained distributions.

12. The method of claim 9 wherein the average total number medical claims n′ₜᵣᵤₑ based on the observed number of medical claims n_{obs} is estimated by:
using the estimated values a and pₜ to estimate the fraction f of patients whose claims are submitted to medical-claims-paying institutions that submit medical claims to the particular claims-processing institution based on a relative proportion of medical-claims-paying institutions serviced by the particular claims-processing institution; and
determining n′ₜᵣᵤₑ as the sum of a and the product of a first term n_{obs}-a and a second term
$$1 + \frac{1 - f}{f} {p}_{t} .$$

13. The method of claim 9 further including correcting the average total number medical claims n′ₜᵣᵤₑ to account for the fact that only a portion of the medical-claims-paying institutions that submit medical claims to the particular claims-processing institution exclusively submit medical claims to the particular claims-processing institution.

14. A data-processing system comprising:
one or more processors;
one or more memories;
one or more mass-storage devices; and
computer instructions, encoded in a physical computer-instruction-storage device, that control the data-processing system to
partition a total, multi-dimensional volume of medical patients into cells; and
estimate an average total number medical claims, n_{c}, for each cell c filed during a particular time interval based on the observed number of medical claims, n_{c}_{_{—}}_{cobs}, for each cell c filed during a particular time interval that represents a fraction of the total number medical claims filed during the particular time interval.

15. The data-processing system of claim 14 wherein the dimensions are medical-patient attributes selected from among medical-patient attributes that include:
geographical location;
gender;
age;
income;
ethnicity;
educational level;
citizenship; and
occupation

16. The data-processing system of claim 14 wherein n_{c} is estimated as
$${n}_{c} = \frac{( {n}_{c\_obs} + {kn}_{true} )}{( β {p}_{c\_obs} + k )}$$
where p_{c}_{_{—}}_{obs}=number of patients in cell;
nₜᵣᵤₑ=an average number of claims per patient;
k=a smoothing constant; and
β=a determined constant of migration.

17. The data-processing system of claim 16 wherein a global constraint for the model is:
$${n}_{true} = {\sum }_{i ∈ cells} ( \frac{{n}_{c\_obs , i}}{β {p}_{c\_obs , i}} ) {m}_{i}$$
where mᵢ=a fraction of a total population within an area represented by cell i;
P_{c}_{_{—}}_{obs,i}=number of patients in cell i; and
n_{c}_{_{—}}_{obs,i}=number of patients in cell i.

18. The data-processing system of claim 17 wherein the migration constant is obtained by:
$$β = {\sum }_{i ∈ cells} \frac{( {n}_{c\_obs , i} ) ( {m}_{i} )}{( {p}_{c\_obs , i} ) ( {n}_{true} )} .$$

19. A method carried out in a data-processing system having one or more processors, one or more memories, one or more mass-storage devices, and computer instructions, encoded in a physical computer-instruction-storage device, that control the data-processing system to carry out the method, the method comprising:
partitioning a total, multi-dimensional volume of medical patients into cells; and
estimating an average total number medical claims, n_{c}, for each cell c filed during a particular time interval based on the observed number of medical claims, n_{c}_{_{—}}_{obs}, for each cell c filed during a particular time interval that represents a fraction of the total number medical claims filed during the particular time interval.

20. The method of claim 19 wherein n_{c} is estimated as
$${n}_{c} = \frac{( {n}_{c\_obs} + {kn}_{true} )}{( β {p}_{c\_obs} + k )}$$
where p_{c}_{_{—}}_{obs}=number of patients in cell;
nₜᵣᵤₑ=an average number of claims per patient;
k=a smoothing constant; and
β=a determined constant of migration.

21. The method of claim 15 wherein a global constraint for the model is:
$${n}_{true} = {\sum }_{i ∈ cells} ( \frac{{n}_{c\_obs , i}}{β {p}_{c\_obs , i}} ) {m}_{i}$$
where mᵢ=a fraction of a total population within an area represented by cell i;
p_{c}_{_{—}}_{obs,i}=number of patients in cell i; and
n_{c}_{_{—}}_{obs,i}=number of patients in cell i.

22. The method of claim 20 wherein the migration constant β is obtained by:
$$β = {\sum }_{i ∈ cells} \frac{( {n}_{c\_obs , i} ) ( {m}_{i} )}{( {p}_{c\_obs , i} ) ( {n}_{true} )} .$$
